(19) United States
(12) Patent Application Publication
(10) Pub. No.: US 2025/0196097 A1
(43) Pub. Date: Jun. 19, 2025

(54) RANDOM COPOLYMER, FINE PARTICLE ADSORBENT, COMPOSITION FOR FORMING FINE PARTICLE-ADSORBING COATING FILM, AND COATING FILM

(71) Applicants: NATIONAL UNIVERSITY CORPORATION UNIVERSITY OF TOYAMA, Toyama (JP); OSAKA ORGANIC CHEMICAL INDUSTRY LTD., Osaka (JP)

(72) Inventors: Tadashi NAKAJI, Toyama (JP); Shinpei YAMAMOTO, Ishikawa (JP)

(21) Appl. No.: 18/881,104

(22) PCT Filed: Jul. 13, 2023
(86) PCT No.: PCT/JP2023/025874

§ 371 Date: Jan. 3, 2025

(30) Foreign Application Priority Data
Jul. 14, 2022 (JP) 2022-113364

(51) Int. Cl. B01J 20/26; B01D 46/00; B01J 20/32; C08F 220/18

(52) U.S. Cl. CPC B01J 20/261; B01J 20/3276; C08F 220/1804; B01D 46/0036; C08F 2800/10

(57) ABSTRACT

The present invention relates to a random copolymer comprising a structural unit represented by Formula (I) and a structural unit represented by Formula (II): [in Formulas (I) and (II), R¹ and R³ each independently represent a hydrogen atom or an alkyl group having 1 to 3 carbon atoms; R² represents an alkyl group having 1 to 6 carbon atoms; R⁴ represents an alkylene group having 1 to 3 carbon atoms; R⁵ represents an alkyl group having 1 to 6 carbon atoms; n represents an integer of 1 to 15; and * represents a bond with an adjacent structural unit].

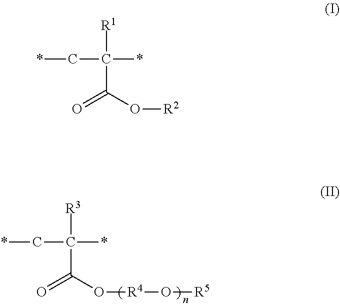

### TECHNICAL FIELD

The present invention relates to a random copolymer, a fine particle adsorbent, a composition for forming a fine particle-adsorbing coating film, and a coating film.

### BACKGROUND ART

Fine particles suspended in the air, such as pollen, viruses, house dust, and fine particulate matters (PM2.5), are substances that potentially impose undesirable effects on the human body. For example, with regard to pollen, the number of people who develop hay fever has been increasing year after year in Japan. To this day, no reliable fundamental therapy has been established for hay fever. A general measure against hay fever is to reduce the chance and the amount of exposure to pollen. With regard to fine particles such as viruses and house dust as well, it is desired to reduce the chance and the amount of contact from the standpoint of inhibiting their effects on the human body and preventing the development of allergies and the like. Further, dust such as fine particulate matters that are derived from gaseous air pollutants emitted from factories, automobiles, ships, airplanes, volcanoes, soil, and the like, for example, soot, sulfur oxides (Sox), nitrogen oxides (NOx), and volatile organic compounds (VOC), can cause respiratory diseases such as asthma and allergic diseases; therefore, it is desired to reduce the chance and the amount of contact with these substances. Moreover, since the entry of these substances into the body leads to the development of allergies and the like, it is also required to adsorb these substances in order to prevent their entry into the body.

For example, Patent Document 1 discloses an allergen adsorbent composition that contains a powder of kaolin or the like in an aqueous medium having a pH of 3 to 7. Further, Patent Document 2 discloses a pollen adsorbent which contains a specific graft side chain in the main chain of a polymer material formed of fibers or fiber assemblies, and in which a triiodide ion is supported on the graft side chain.

### PRIOR ART DOCUMENT

### Patent Document

Patent Document 1: JP 2002-167332 A
Patent Document 2: WO 2008/153090

### SUMMARY OF THE INVENTION

### Problems to be Solved by the Invention

Allergens exist on the surface and inside of pollen particles, and allergies develop when the allergens enter the body and bind with antibodies. Particularly, it is known that such allergens are released as a result of rupture of pollen, and the allergens are much smaller than pollen themselves and thus easily enter the body, reaching the deep parts of the respiratory system. Further, fine particles such as viruses and house dust are more likely to enter the body when reduced in size. For example, the adsorbent disclosed in Patent Document 1 is aimed at adsorbing allergens themselves that are released from pollen particles; however, since allergens have already been released, the effect of preventing the entry of allergens into the body may not be sufficient. The adsorbent of Patent Document 2 is also intended to adsorb released allergenic proteins.

However, when pollen and the like are adsorbed without being ruptured, since allergens are not released, it is believed possible to reduce the chance of contact with allergens. Therefore, an object of the present invention is to provide a fine particle adsorbent capable of adsorbing fine particles, such as pollen, viruses, and house dust, while inhibiting the rupture of the fine particles, particularly a pollen adsorbent.

### Solutions to the Problems

In order to solve the above-described problems, the present invention provides the following preferred modes.

[1] A random copolymer, comprising a structural unit represented by Formula (I) and a structural unit represented by Formula (II):

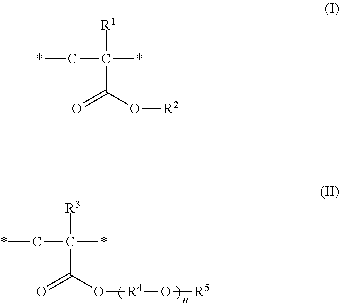

[in Formulas (I) and (II),
R¹ and R³ each independently represent a hydrogen atom or an alkyl group having 1 to 3 carbon atoms;
R² represents an alkyl group having 1 to 6 carbon atoms;
R⁴ represents an alkylene group having 1 to 3 carbon atoms;
R⁵ represents an alkyl group having 1 to 6 carbon atoms;
n represents an integer of 1 to 15; and
* represents a bond with an adjacent structural unit].

[2] The random copolymer according to [1], wherein the structural unit represented by Formula (II) is derived from a monomer having a Tg of −100 to 15° C.

[3] The random copolymer according to [1] or [2], wherein the amount of the structural unit of Formula (I) is 50 to 99% by mole, and the amount of the structural unit of Formula (II) is 1 to 50% by mole, based on the amount of all structural units of the random copolymer.

[4] The random copolymer according to any one of [1] to [3], having a weight-average molecular weight of 50,000 to 300,000.

[5] A fine particle adsorbent, comprising the random copolymer according to any one of [1] to [4].

[6] The fine particle adsorbent according to [5], wherein a fine particle is pollen.

[7] A composition for forming a fine particle-adsorbing coating film, the composition comprising the random copolymer according to any one of [1] to [4].

[8] The composition for forming a fine particle-adsorbing coating film according to [7], wherein a fine particle is pollen.

[9] The composition for forming a fine particle-adsorbing coating film according to [7] or [8], further comprising a solvent.

[10] A coating film, formed from the composition for forming a fine particle-adsorbing coating film according to any one of [7] to [9].

[11] The coating film according to [10], having an elastic modulus of 0.1 to 1.0 MPa, and an adhesiveness of 1.0 nm/nN or more.

### Effects of the Invention

According to the present invention, a fine particle adsorbent capable of adsorbing fine particles, such as pollen, viruses, and house dust, while inhibiting the rupture of the fine particles, particularly a pollen adsorbent, can be provided.

### DETAILED DESCRIPTION

Embodiments of the present invention will now be described in detail. It is noted here, however, that the scope of the present invention is not limited to the embodiments described below, and various modifications can be made without departing from the gist of the present invention.

The present invention provides:
a random copolymer comprising a structural unit represented by Formula (I) and a structural unit represented by Formula (II):

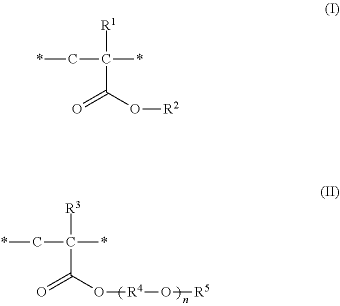

[in Formulas (I) and (II),
R¹ and R³ each independently represent a hydrogen atom or an alkyl group having 1 to 3 carbon atoms;
R² represents an alkyl group having 1 to 6 carbon atoms;
R⁴ represents an alkylene group having 1 to 3 carbon atoms;
R⁵ represents an alkyl group having 1 to 6 carbon atoms;
n represents an integer of 1 to 15; and
* represents a bond with an adjacent structural unit]; and
a fine particle adsorbent comprising the random copolymer.

The copolymer of the present invention is a random copolymer that randomly comprises one or more structural units represented by Formula (I), and one or more structural units represented by Formula (II). Hereinafter, a structural unit represented by Formula (I) is also referred to as “structural unit (I)”, and a structural unit represented by Formula (II) is also referred to as “structural unit (II)”. The copolymer of the present invention may be a random copolymer composed of a structural unit (I) and a structural unit (II), or may be a random copolymer composed of a structural unit (I), a structural unit (II), and other structural unit different from the structural units (I) and (II). Surprisingly, the copolymer of the present invention that comprises randomly repeated structural units (I) and (II) can provide a coating film or the like that not only exhibits a high adsorption performance for fine particles such as pollen, viruses, and house dust but also can inhibit the rupture of these fine particles. The reason for this is not clear; however, a coating film formed by the copolymer of the present invention is adhesive to fine particles such as pollen; therefore, the coating film can allow the fine particles to adhere to its surface. The adhered fine particles may be damaged by an impact or the like of adhesion, and particularly, pollen is known to rupture also by absorbing moisture in a high-humidity condition. It is believed that not only fine particles are unlikely to be damaged at the time of adhering to the surface of a coating film comprising the copolymer of the present invention, but also the adhered fine particles are at least partially embedded in the surface of the coating film depending on the case, as a result of which the rupture caused by moisture absorption in a high-humidity condition is inhibited as well. Therefore, a fine particle adsorbent comprising the random copolymer of the present invention is a fine particle adsorbent capable of adsorbing fine particles, such as pollen, viruses, and house dust, while inhibiting the rupture of these fine particles. It is noted here that the fine particle adsorbent may be a formulation for providing fine particle adsorption performance, or a raw material component used for the production of such a formulation.

In Formula (I), R¹ represents a hydrogen atom or an alkyl group having 1 to 3 carbon atoms. Examples of the alkyl group having 1 to 3 carbon atoms include a methyl group, an ethyl group, a propyl group, and a 1-methylethyl group. From the standpoint of easily producing the random copolymer (facilitating the polymerization with other structural unit), R′ is preferably a hydrogen atom or a methyl group.

In Formula (I), R² represents an alkyl group having 1 to 6 carbon atoms. Examples of the alkyl group having 1 to 6 carbon atoms include a methyl group, an ethyl group, a propyl group, a 1-methylethyl group, a butyl group, an isobutyl group, a tert-butyl group, a pentyl group, and a hexyl group. From the standpoint of improving the adsorption performance and inhibiting the rupture of fine particles, the number of carbon atoms of R² is preferably 1 to 5.

In Formula (II), R³ represents a hydrogen atom or an alkyl group having 1 to 3 carbon atoms. Examples of the alkyl group having 1 to 3 carbon atoms include the same groups as those exemplified above for R¹. From the standpoint of the ease of producing the random copolymer (facilitating the polymerization with other structural unit), R³ is preferably a hydrogen atom or a methyl group.

In Formula (II), R⁴ represents an alkylene group having 1 to 3 carbon atoms. Examples of the alkylene group having 1 to 3 carbon atoms include a methylene group, an ethylene group, a propylene group, and a methylethylene group. From the standpoint of inhibiting the rupture of fine particles, R⁴ is preferably a methylene group or an ethylene group.

In Formula (II), R⁵ represents an alkyl group having 1 to 6 carbon atoms, Examples of the alkyl group having 1 to 6 carbon atoms include the same groups as those exemplified above for R². From the standpoint of improving the adsorption performance and inhibiting the rupture of fine particles, the number of carbon atoms of R⁵ is preferably 1 to 5, more preferably 1 to 4.

In Formula (II), n represents an integer of 1 to 15. From the standpoint of inhibiting the rupture of fine particles, n represents preferably 1 to 12, more preferably 1 to 10, still more preferably 1 to 5.

The random copolymer of the present invention is preferably a polymer having a (meth)acryl skeleton. The term “(meth)acryl” used herein means acryl and/or methacryl. The random copolymer of the present invention is a copolymer comprising a structural unit represented by Formula (I) and a structural unit represented by Formula (II) that are randomly repeated, optionally along with other structural unit. A ratio of a total amount of the structural units (1) and (II) is preferably 50% by mole or more, more preferably 70% by mole or more, still more preferably 80% by mole or more, yet still more preferably 90% by mole or more, particularly preferably 95% by mole or more, with respect to the amount of all structural units constituting the random copolymer of the present invention. An upper limit of the ratio of the total amount is 100% by mole or less.

The structural unit represented by Formula (I) that is comprised in the random copolymer of the present invention is, for example, a structural unit derived from a (meth)acryl monomer represented by the following Formula (I-a):

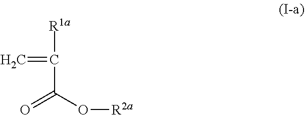

With regard to R^{1a} and R^{2a} of Formula (I-a), the descriptions relating to R¹ and R² of Formula (I) apply in the same manner, respectively. The (meth)acryl monomer represented by Formula (I-a) is preferred since it not only is easily copolymerizable with the below-described monomer represented by Formula (II-a), but also is likely to form a coating film.

The structural unit represented by Formula (II) that is comprised in the random copolymer of the present invention is, for example, a structural unit derived from a (meth)acryl monomer represented by the following Formula (II-a):

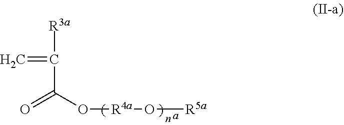

With regard to R^{3a}, R^{4a}, and R^{5a} of Formula (II-a), the descriptions relating to R³, R⁴, and R⁵ of Formula (II) apply in the same manner, respectively.

In one preferred mode of the present invention, from the standpoint of improving the fine particle adsorption performance and the fine particle rupture-inhibiting performance of the copolymer of the present invention and a fine particle adsorbent comprising the copolymer, the structural unit represented by Formula (II) is preferably derived from a monomer having a glass transition temperature (Tg) of −100 to 15° C. When the copolymer of the present invention has the structural unit represented by Formula (II) that is derived from a monomer having a Tg of −100 to 15° C., a flexible structure having a low Tg is randomly incorporated into the copolymer. It is believed that, as a result, not only the adsorption performance for fine particles can be improved but also the rupture of fine particles is likely to be inhibited by flexible structural parts. From the standpoint of making the effects of the present invention more likely to be exerted when using the fine particle adsorbent of the present invention particularly in a normal temperature environment, as well as from the standpoint of the ease of handling at the time of applying the fine particle adsorbent of the present invention to an object of interest or the like, the Tg of the monomer is more preferably-90° C. to 5° C., still more preferably −80° C. to −5° C., yet still more preferably −70° C. to −10° C. The Tg of the monomer can be measured by, for example, the method described below in the section of Examples. It is noted here that the Tg of the monomer refers to the Tg of a homopolymer of the monomer. When there is a known literature value, this value was used as the Tg of the monomer, whereas when there is no known literature value or the like, for example, a value obtained by preparing a homopolymer by homopolymerization of the monomer under the polymerization conditions described below in the section of Examples and measuring the Tg of the resulting homopolymer is used as the Tg of the monomer.

Based on the amount of all structural units of the random copolymer of the present invention, the amount of the structural unit of Formula (I) is preferably 50 to 99% by mole, and the amount of the structural unit of Formula (II) is preferably 1 to 50% by mole. When the amount of the structural unit of Formula (II) is equal to or more than the above-described lower limit, not only the adsorption performance for fine particles can be improved but also the rupture of fine particles is likely to be inhibited and, when the amount of the structural unit of Formula (II) is equal to or less than the above-described upper limit, the strength of a coating film or the like that contains the copolymer of the present invention is likely to be improved to a certain extent, and a fine particle adsorption effect is thus likely to be maintained over an extended period. When the amount of the structural unit of Formula (I) is equal to or more than the above-described lower limit, the strength of a coating film or the like that comprises the copolymer of the present invention is likely to be improved to a certain extent, and a fine particle adsorption effect is thus likely to be maintained over an extended period. Further, when the amount of the structural unit of Formula (I) is equal to or less than the above-described upper limit, not only the adsorption performance for fine particles can be improved but also the rupture of fine particles is likely to be inhibited.

The amount of the structural unit of Formula (I) is preferably 50 to 99% by mole, more preferably 60 to 95% by mole, still more preferably 65 to 90% by mole, based on the amount of all structural units of the random copolymer.

The amount of the structural unit of Formula (II) is preferably 1 to 50% by mole, more preferably 5 to 40% by mole, still more preferably 10 to 35% by mole, based on the amount of all structural units of the random copolymer.

The amount of the structural unit of Formula (I) is preferably 50 to 99% by mole, more preferably 60 to 95% by mole, still more preferably 65 to 90% by mole, based on a total amount of the structural unit of Formula (I) and the structural unit of Formula (II) that are comprised in the random copolymer.

The amount of the structural unit of Formula (II) is preferably 1 to 50% by mole, more preferably 5 to 40% by mole, still more preferably 10 to 35% by mole, based on a total amount of the structural unit of Formula (I) and the structural unit of Formula (II) that are comprised in the random copolymer.

Examples of other structural units that may be comprised in the random copolymer include structural units derived from the following monomers:
hydroxy group-containing ethylenically unsaturated monomers, such as hydroxyethyl (meth)acrylate, hydroxypropyl (meth)acrylate, and hydroxybutyl (meth)acrylate;
alkyl (meth)acrylate ester monomers, such as methyl (meth)acrylate, ethyl (meth)acrylate, n-butyl (meth)acrylate, t-butyl (meth)acrylate, isobutyl (meth)acrylate, n-pentyl (meth)acrylate, n-hexyl (meth)acrylate, cyclohexyl (meth)acrylate, 2-ethylhexyl (meth)acrylate, dodecyl (meth)acrylate, tridecyl (meth)acrylate, lauryl (meth)acrylate, and stearyl (meth)acrylate;
glycidyl group-containing ethylenically unsaturated monomers, such as glycidyl acrylate and glycidyl methacrylate;
vinyl esters of saturated aliphatic carboxylic acids, such as vinyl acetate and vinyl propionate;
styrene-based monomers, such as styrene, «-methylstyrene, and vinyl toluene;
amide group-containing ethylenically unsaturated monomers, such as (meth)acrylamide, N-methylol (meth)acrylamide, N-methoxybutyl (meth)acrylamide, diacetone (meth)acrylamide, N,N-dimethylaminopropyl (meth)acrylamide, and N-t-butyl (meth)acrylamide; and
other ethylenically unsaturated monomers, such as N-vinylpyrrolidone and methoxypolyethylene glycol mono(meth)acrylate.

If necessary, these monomers may be used singly, or in combination of two or more kinds thereof.

The random copolymer of the present invention has a weight-average molecular weight (Mw) of preferably 5,000 to 1,000,000, more preferably 10,000 to 700,000, still more preferably 30,000 to 500,000, yet still more preferably 50,000 to 300,000. The weight-average molecular weight is preferably equal to or more than the above-described lower limit from the standpoint of the ease of applying the random copolymer to an object of interest and uniformly coating the object, and the weight-average molecular weight is preferably equal to or less than the above-described upper limit from the standpoint of improving the adsorption performance and inhibiting the rupture of fine particles. The weight-average molecular weight of the random copolymer can be measured by the method described below in the section of Examples.

The random copolymer of the present invention has a number-average molecular weight (Mn) of preferably 1,000 to 500,000, more preferably 3,000 to 300,000, still more preferably 5,000 to 200,000, yet still more preferably 10,000 to 100,000. The number-average molecular weight is preferably equal to or more than the above-described lower limit from the standpoint of the ease of applying the random copolymer to an object of interest and uniformly coating the object, and the number-average molecular weight is preferably equal to or less than the above-described upper limit from the standpoint of improving the adsorption performance and inhibiting the rupture of fine particles. The number-average molecular weight of the random copolymer can be measured by the method described below in the section of Examples.

The random copolymer of the present invention has a polydispersity (Mw/Mn) of preferably 2.0 to 4.0, more preferably 2.5 to 3.5. The polydispersity is preferably equal to or more than the above-described lower limit from the standpoint of the case of applying the random copolymer to an object of interest and uniformly coating the object, and the polydispersity is preferably equal to or less than the above-described upper limit from the standpoint of improving the adsorption performance and inhibiting the rupture of fine particles.

From the standpoint of improving the adsorption performance and inhibiting the rupture of fine particles, the random copolymer of the present invention has a glass transition temperature Tg of preferably −60° C. or higher, more preferably −40° C. or higher, still more preferably −20° C. or higher, particularly preferably −10° C. or higher. From the same standpoint, the glass transition temperature Tg is preferably 20° C. or lower, more preferably 15° C. or lower, still more preferably 10° C. or lower. The glass transition temperature Tg of the random copolymer of the present invention is determined by the Fox equation. Specifically, the Tg₀(K) of a copolymer comprising a first structural unit and a second structural unit can be estimated by the following equation, wherein the Tg of a homopolymer of the first structural unit comprised in the copolymer, the mass fraction of the first structural unit in the copolymer, the Tg of a homopolymer of the second structural unit, and the mass fraction of the second structural unit in the copolymer are defined as Tg₁, W₁, Tg₂, and W₂, respectively:

$$Fox equation : 1 / {Tg}_{0} = ( {W}_{1} / {Tg}_{1} ) + ( {W}_{2} / {Tg}_{2} )$$

From the standpoint of improving the strength of a coating film or the like that comprises the random copolymer of the present invention and maintaining a fine particle adsorption effect, the random copolymer of the present invention has an elastic modulus, which is measured under a condition of 30 to 40% RH in the form of a coating film formed by applying a solution of the random copolymer onto a PET (polyethylene terephthalate) sheet by a spin coating method and subsequently drying the applied solution, of preferably 0.1 MPa or more, more preferably 0.2 MPa or more, still more preferably 0.3 MPa or more. From the standpoint of improving the fine particle adsorption performance and inhibiting the rupture of adsorbed fine particles, the elastic modulus is preferably 1.5 MPa or less, more preferably 1.0 MPa or less, still more preferably 0.8 MPa or less. The elastic modulus can be measured by, for example, the method described below in the section of Examples.

From the standpoint of improving the fine particle adsorption performance and inhibiting the rupture of adsorbed fine particles, the random copolymer of the present invention has an adhesiveness, which is measured under a condition of 30 to 40% RH in the form of a coating film formed by applying a solution of the random copolymer onto a PET sheet by a spin coating method and subsequently drying the applied solution, of preferably 0.6 nm/nN or more, more preferably 1.0 nm/nN or more, still more preferably 1.5 nm/nN or more. From the standpoint of improving the ease of handling, the adhesiveness is preferably 15 nm/nN or less, more preferably 12 nm/nN or less, still more preferably 10 nm/nN or less. The adhesiveness can be measured by the method described below in the section of Examples.

From the standpoint of improving the adsorption performance and inhibiting the rupture of fine particles, the random copolymer of the present invention has a surface zeta potential of preferably −4.0 mV or more, more preferably −2.0 mV or more, still more preferably −0.5 mV or more, as measured by the method described below in the section of Examples. From the standpoint of improving the ease of handling, the surface zeta potential is preferably 4.0 mV or less, more preferably 2.0 mV or less, still more preferably 1.5 mV or less.

The random copolymer of the present invention can be prepared by random copolymerization of a monomer mixture that comprises a monomer giving the structural unit (I), a monomer giving the structural unit (II), and optionally other monomer. The polymerization of the monomer mixture can be performed by any method that is normally employed by a person of ordinary skill in the art and, for example, the monomer mixture can be polymerized by heating or photoirradiation. Specific examples of a polymerization method include a bulk polymerization method, a precipitation polymerization method, a suspension polymerization method, an emulsion polymerization method, a solution polymerization method, and a mass polymerization method. Among these polymerization methods, taking into consideration the use of the random copolymer as a fine particle adsorbent, the random copolymer is more preferably prepared by a solution polymerization method in which copolymerization is performed in advance in water, a hydrophilic solvent, or a mixture thereof.

The term “hydrophilic solvent” used herein refers to an organic solvent having a solubility in water of not less than 10 g/100 g of water (25° C.). Specific examples of such a hydrophilic solvent include aliphatic monohydric to tetrahydric alcohols having 1 to 4 carbon atoms, ethyl cellosolve, butyl cellosolve, dioxane, methyl acetate, and dimethylformamide. Among these hydrophilic solvents, it is particularly preferred to use a monohydric or dihydric alcohol.

Examples of the monohydric alcohol include methanol, ethanol, and isopropanol. Examples of the dihydric alcohol include propylene glycol. Thereamong, ethanol or isopropanol is particularly preferred.

Solution polymerization of the above-described monomer mixture can be performed by dissolving the monomer mixture in a solvent such as water, a mixture of water and a hydrophilic solvent, or a hydrophilic solvent, subsequently adding a polymerization initiator, and then stirring the resultant with heating. The polymerization is more preferably performed in an inert gas atmosphere, such as nitrogen gas or argon gas.

As the polymerization initiator, any polymerization initiator that is generally used in a solution polymerization method can be used. Examples of the polymerization initiator include: peroxides, such as benzoyl peroxide and lauroyl peroxide; and azo compounds, such as azobisisobutyronitrile. Among these polymerization initiators, it is preferred to use an azo compound from the standpoint of, for example, controlling the polymerization reaction.

In the above-described polymerization, the amount of the solvent is preferably adjusted such that the concentration of the mixture of monomer components is about 30 to 60% by weight. The polymerization temperature and the polymerization time can be selected as appropriate in accordance with, for example, the types of the monomers contained in the monomer mixture, the type of the polymerization initiator, and the scale of the reaction. For example, it is preferred to perform the polymerization at a temperature close to the reflux temperature of the polymerization solvent. The polymerization time is preferably 8 hours or longer, more preferably 12 to 36 hours.

### [Fine Particle]

The random copolymer of the present invention can be used in the form of a fine particle adsorbent comprising the random copolymer. The fine particle adsorbent is an agent having a fine particle adsorption effect and may be specifically, for example, a fine particle adsorption product that can temporarily impart fine particle adsorption performance to an object coated or sprayed therewith, or a raw material for the production of such a fine particle adsorption product. Examples of fine particles include pollen, viruses, bacteria, fungi, dust (e.g., sooty smoke, soot, and fine particulate matters (PM2.5) derived from gaseous air pollutants, such as sulfur oxides (SOx), nitrogen oxides (NOx), and volatile organic compounds (VOC)), yeast, protozoa, spores, animal skin fragments, mite excrement and carcasses, and house dust that may contain any of the above. From the standpoint of the ease of obtaining the fine particle adsorption performance, the fine particles are selected from the group consisting of viruses, bacteria, fungi, dust, yeast, protozoa, spores, animal skin fragments, mite excrement and carcasses, and house dust that may contain any of the above, and the fine particles are more preferably pollen. The fine particles are, for example, fine particles having a size that makes them suspendable in the air (fine particles having a diameter of preferably 60 μm or less, more preferably 30 μm or less, still more preferably 20 μm or less), preferably pollen and/or viruses, and more preferably pollen.

Examples of the pollen include pollen of Cupressaceae plants (e.g., genus Cryptomeria and genus Chamaecyparis), pollen of Poaceae plants (e.g., genus Dactylis and genus Phleum), pollen of Asteraceae plants (e.g., genus Ambrosia and genus Artemisia), and pollen of Betulaceae plants (e.g., Japanese white birch); however, the type of the pollen is not limited thereto.

Examples of the viruses include influenza virus, herpesvirus, rubella virus, coronavirus, Ebola virus, hepatitis virus, rabies virus, norovirus, rotavirus, poliovirus, and adenovirus; however, the type of the virus is not limited thereto.

Examples of the bacteria include Gram-positive bacteria (e.g., staphylococcus bacteria, streptococcus bacteria, Bacillus subtilis, Mycobacterium tuberculosis, and Clostridium botulinum) and Gram-negative bacteria (e.g., Escherichia coli, Salmonella enterica, Pseudomonas aeruginosa, and Vibrio cholerae); however, the type of the bacteria is not limited thereto.

Examples of the fungi include those belonging to the genera Trichophyton, Candida, and Aspergillus; however, the type of the fungi is not limited thereto.

Examples of the dust include fine particulate matters (PM2.5) and sooty smoke in the form of particles (e.g., sulfur oxides (SOx), smoke dust (so-called soot), and hazardous substances (cadmium and compounds thereof, chlorine, hydrogen chloride, fluorine, hydrogen fluoride, silicon fluoride, lead and compounds thereof, and nitrogen oxides (NOx)), which are generated by combustion and the like of materials); however, the type of the dust is not limited thereto.

Examples of the fine particles also include yeast, protozoa, spores, animal skin fragments, and mite excrement and carcasses.

Examples of the house dust include those containing at least two or more of the above-described pollen, viruses, bacteria, fungi, dust, and fine particles.

### [Fine Particle Adsorbent]

The fine particle adsorbent may further comprise a medium such as a solvent in addition to the above-described random copolymer of the present invention. Examples of the solvent include, but not particularly limited to, water, a hydrophilic solvent, and a mixture thereof as described above. Examples of a form of the fine particle adsorbent include, but not particularly limited to, a liquid, a gel, a spray, a mist, a lotion, a cream, an emulsion, a foundation, an overcoat agent, and a detergent. The type of the medium can be selected as appropriate in accordance with the form of the fine particle adsorbent. The fine particle adsorbent may further comprise additives, such as a surfactant, a UV absorber, and an antioxidant, as well as a fragrance and the like. In other words, when the fine particles to be adsorbed contains a UV absorber, an antioxidant, and the like, it is expected that the fine particle adsorbent of the present invention can inhibit the detachment of the fine particles from the surface of an object to be coated, and maintain the effects attributed to the fine particles.

For example, by coating or spraying filters, bodies, hair, clothes, bedding covers, accessories (e.g., masks, glasses, goggles, hats, mufflers, and scarves), and the like with the fine particle adsorbent of the present invention, the copolymer of the present invention is applied to these objects, as a result of which the objects can be imparted with fine particle adsorption performance.

The fine particle adsorbent of the present invention may be, for example, a composition for forming a fine particle-adsorbing coating film, which composition comprises the random copolymer of the present invention. The present invention thus also provides a composition for forming a fine particle-adsorbing coating film. The composition for forming a fine particle-adsorbing coating film is a composition used for the formation of a coating film having fine particle adsorption performance, and a form thereof is not particularly limited and may be, for example, a liquid composition that comprises the copolymer of the present invention and at least one solvent. By applying the composition for forming a fine particle-adsorbing coating film to an object of interest by coating, spraying, or the like, and subsequently drying the composition, a coating film having fine particle adsorption performance can be formed on the object. Examples of the solvent and other components that may be contained in the composition for forming a fine particle-adsorbing coating film include those solvents and components that are exemplified above in relation to the fine particle adsorbent.

The content of the copolymer of the present invention in the fine particle adsorbent of the present invention may be adjusted as appropriate in accordance with the intended use of the fine particle adsorbent and, from the standpoint of improving the effects of the fine particle adsorption performance, it is, for example, 1% by mass or more, 3% by mass or more, 5% by mass or more, or 10% by mass or more, based on the solid content of the fine particle adsorbent.

The present invention also provides a coating film formed from the above-described composition for forming a fine particle-adsorbing coating film. In other words, the coating film of the present invention is a coating film that comprises a random copolymer having the above-described structural unit represented by Formula (I) and structural unit represented by Formula (II). A method of forming the coating film is not particularly limited, and the coating film is formed by applying the composition for forming a fine particle-adsorbing coating film according to the present invention to an object of interest by coating, spraying, or the like, and subsequently drying the composition and thereby removing the solvent and the like.

From the standpoint of improving the strength of a coating film or the like that contains the copolymer and maintaining a fine particle adsorption effect, the coating film of the present invention has an elastic modulus of preferably 0.1 MPa or more, more preferably 0.2 MPa or more, still more preferably 0.3 MPa or more. From the standpoint of improving the fine particle adsorption performance and inhibiting the rupture of adsorbed fine particles, the elastic modulus is preferably 2.5 MPa or less, more preferably 1.5 MPa or less, still more preferably 1.0 MPa or less, particularly preferably 0.7 MPa or less. The elastic modulus can be measured by, for example, the method described below in the section of Examples. As described below in the section of Examples, the elastic modulus is measured under a condition of 30 to 35% RH.

From the standpoint of improving the fine particle adsorption performance and inhibiting the rupture of adsorbed fine particles, the coating film of the present invention has an adhesive strength of preferably 0.6 nm/nN or more, more preferably 1.0 nm/nN or more, still more preferably 2.0 nm/nN or more. From the standpoint of the ease of handling, the adhesive strength is preferably 6.0 nm/nN or less, more preferably 5.0 nm/nN or less, still more preferably 4.0 nm/nN or less, yet still more preferably 3.5 nm/nN or less. The adhesive strength can be measured by, for example, the method described below in the section of Examples. As described below in the section of Examples, the adhesive strength is measured under a condition of 30 to 35% RH.

From the standpoint of improving the fine particle adsorption performance, the coating film of the present invention has a surface zeta potential of preferably −10 mV or more, more preferably −5.0 mV or more, still more preferably −3.0 mV or more, particularly preferably −1.5 mV. From the standpoint of improving the fine particle adsorption performance, the surface zeta potential is preferably 10 mV or less, more preferably 5.0 mV or less, still more preferably 3.0 mV or less. The surface zeta potential can be measured by, for example, the method described below in the section of Examples.

### EXAMPLES

The present invention will now be described in more detail by way of Examples; however, the present invention is not limited to the below-described Examples by any means. Unless otherwise specified, “%” and “part(s)” in Examples mean “% by mass” and “part(s) by mass”, respectively.

### (Glass Transition Temperature Tg of Monomer)

The Tg of a monomer refers to the Tg of a homopolymer of the monomer. When there was a known literature value, this value was used as the Tg of the monomer, whereas when there was no known literature value or the like, a value obtained by preparing a homopolymer by homopolymerization of the monomer under the below-described polymerization conditions and measuring the Tg of the resulting homopolymer was used as the Tg of the monomer.

### Polymerization Conditions

A monomer and a polymerization initiator were injected into a molding die (prepared by pasting a mold release film to each of two glass plates, arranging the two glass plates such that their mold release films faced each other, forming therebetween a region of 100 mm in length and 100 mm in width using a 4 mm-thick silicon spacer, and then sandwiching the silicon spacer with the two glass plates such that the gap therebetween was about 2 to 4 mm). This molding die was irradiated with UV light (wavelength: 365 nm) for 1 hour using an LED exposure machine to obtain a polymer. The thus obtained polymer was weighed in an amount of 10 mg, set in a differential scanning calorimeter (DSC7000X, manufactured by Hitachi High-Tech Science Corporation), and measured at a heating rate of 10° C./min in a temperature range of −130° C. to 100° C. The temperature of an endothermic peak derived from the polymer during the first heating process was determined as the glass transition temperature (Tg) of the polymer, and this value was defined as the Tg of the monomer.

### (Glass Transition Temperature Tg of Random Copolymer)

The glass transition temperature Tg of the random copolymer of the present invention was determined by the Fox equation in the above-described manner. It is noted here that the Fox equation was applied assuming that the monomers used all reacted to form the random copolymer. The same also applies to each of the copolymers and the homopolymers in the below-described Comparative Examples.

### (Weight-Average Molecular Weight Mw, Number-Average Molecular Weight Mn, and Mw/Mn)

The weight-average molecular weight (Mw) and the number-average molecular weight (Mn) were both measured in accordance with JIS K7252-1:2016. It is noted here that both values are based on a polystyrene standard sample.

The structure, the Tg, and the molecular weight of each monomer used in the below-described Examples and Comparative Examples are as shown in Table 1.

TABLE 1

| Abbreviation | Compound name and structural formula | Tg (° C.) | Molecular weight |
|---|---|---|---|
| BMA | Butyl methacrylate | 20 | 142.2 |
| | 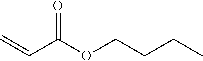 | | |
| MEA | Methoxyethyl acrylate | −50 | 130.1 |
| | 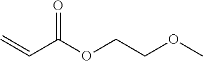 | | |
| PEGMEMA | Polyethylene glycol methyl ether methacrylate (n = 9) | −64 | 468 |
| | 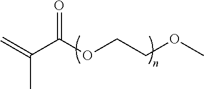 | | |
| DMAEMA | Dimethylaminoethyl methacrylate | 18 | 157.2 |
| | 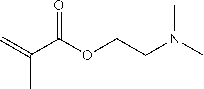 | | |
| BzMA | Benzyl methacrylate | 54 | 176.2 |
| | 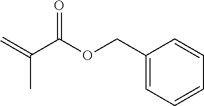 | | |
| MA | Methacrylic acid | 185 | 86.1 |
| | 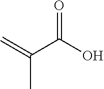 | | |

The above-described monomers used in Examples and Comparative Examples were commercially available products available from Wako Pure Chemical Corporation, except for PEGMEMA. As PEGMEMA, M-90G manufactured by Shin-Nakamura Chemical Co., Ltd. was used.

### Example 1

A monomer mixture composed of 30 parts (parts by mass; the same applies below) of methoxyethyl acrylate and 70 parts of butyl methacrylate, and 150 parts of absolute ethanol were put into a 500-ml five-necked flask equipped with a reflux condenser, a thermometer, a nitrogen introduction tube, a loading tube, and a stirrer, and 0.2 parts of α,α′-azobisisobutyronitrile (hereinafter, referred to as “AIBN”) was added thereto, after which these materials were heated to reflux at 80° C. in a nitrogen stream with stirring. The resulting resin composition was diluted with ethanol to a concentration of 10% by mass to obtain a 10% ethanol solution of a BMA/MEA random copolymer. The results of measuring the weight-average molecular weight and the number-average molecular weight of the thus obtained BMA/MEA random copolymer are shown in Table 2.

### Example 2 and Comparative Examples 1 to 5

Each polymer and 10%-by-mass ethanol solution were prepared and the properties were measured in the same manner as in Example 1, except that the type and the amount of each monomer comprised in the monomer mixture were changed as shown in Table 2 below. The results thereof are shown in Table 2.

### [Evaluation of Coating Film]

### (Surface Zeta Potential)

The 10%-by-mass ethanol solution of each of Examples and Comparative Examples in an amount of 0.4 mL was applied dropwise onto a PET sheet (manufactured by AS ONE Corporation, thickness: 1 mm, 15 mm×30 mm) and spin-coated using a commercially available spin coater to form a coating film. This spin coating was performed at 500 rpm for 10 seconds and then at 2,000 rpm for 60 seconds, whereby a PET sheet test piece of each of Examples and Comparative Examples was produced. This test piece was set in a flat quartz cell for zeta potential measurement (manufactured by Otsuka Electronics Co., Ltd.), and the measurement was performed using a commercially available zeta potential measurement system (ELSZ-2000Z, manufactured by Otsuka Electronics Co., Ltd.). Specifically, a solution obtained by dispersing monitor particles (manufactured by Otsuka Electronics Co., Ltd.) in a 10-mM aqueous sodium chloride solution was introduced to a measuring cell of the potential measurement system to measure the surface zeta potential.

### (Elastic Modulus of Coating Film)

The 10%-by-weight ethanol solution of each of Examples and Comparative Examples in an amount of 0.4 mL was applied dropwise onto a PET sheet (manufactured by AS ONE Corporation, thickness: 1 mm, 10 mm×10 mm) and spin-coated using a commercially available spin coater to form a coating film. This spin coating was performed at 500 rpm for 10 seconds and then at 2,000 rpm for 60 seconds, whereby a PET sheet test piece of each of Examples and Comparative Examples was produced. This test piece was set on a scanning probe microscope (SPM-9700, manufactured by Shimadzu Corporation), and the force curve data were measured using a cantilever, after which, from the thus obtained force curve, the elastic modulus distribution was determined by performing an analysis based on the JKR contact theory (Hertz contact solution (for non-adhesive surface) or a JKR two-point method (improved fitting formula of Hertz contact solution considering the adhesive energy) using an accessory analysis software. The thus obtained data were analyzed using the accessory analysis software to determine the elastic modulus.

The cantilever used for the measurement and the measurement conditions are shown below.

### <Cantilever>

Test piece at a humidity of 30 to 35% RH: SD-R30-FM (NANOSENSORS, spring constant (kc)=2.8 N/m, resonant frequency=75 kHz, curvature radius (R)=2 μm)
Test piece at a humidity of 90 to 95% RH: particle probe (manufactured by Novascan Technologies, Inc., spring constant (kc)=0.12 N/m, resonant frequency=70 kHz, particle size (curvature radius) (R)=10 μm)

### <Measurement Conditions>

Operating point of cantilever on surface: 0.5 V
During force curve measurement: 0 V
Cantilever sweep speed: 0.5 Hz

### (Adhesiveness of Coating Film)

The adhesiveness was evaluated based on the cantilever moving distance (nm), which was required for peeling off the cantilever from the coating film and bringing the cantilever into a state of not applying any force, with respect to the force (nN) applied by the cantilever when in contact with the coating film, which force was read from the force curve data obtained in the measurement of the elastic modulus of the coating film. In other words, the distance (nm) required for peeling off the cantilever adhered to the coating film was divided by the force (nN) applied by the cantilever when in contact with the coating film, and the thus obtained value (nm/nN, distance per unit force) was taken as the adhesiveness of the coating film.

From the force curve data obtained in the above-described measurement of (Elastic Modulus of Coating Film), the adhesiveness was defined by the cantilever moving distance (nm), which was required for peeling off the cantilever from a polymer film and bringing the cantilever into a state of not applying any force, with respect to the force (nN) applied by the cantilever when in contact with the polymer film. In other words, the adhesiveness was evaluated in terms of the distance required for peeling off the cantilever adhered to a polymer coating film (nm/nN, distance per unit force).

### <Preparation of Nonwoven Fabric Test Piece>

A commercially available nonwoven fabric (medical gauze, manufactured by Terumo Corporation) was immersed in the 10%-by-mass ethanol solution obtained in each of Examples and Comparative Examples, and left to stand for 5 minutes. Subsequently, the nonwoven fabric was pulled out of the solution, and excess solution was removed, after which the nonwoven fabric was dried at normal temperature and normal pressure to prepare a nonwoven fabric test piece on the surface of which the copolymer of each of Examples and Comparative Examples was adhered. Using the obtained nonwoven fabric test piece, the same test was conducted as in the below-described evaluation of pollen adsorption performance. When the test piece was observed under a microscope, it was confirmed that unruptured pollen was adsorbed at a high density in the cases of the polymers of Examples 1 and 2. On the other hand, in the cases of the polymers of Comparative Examples, the pollen adsorption density was low, and pollen rupture was confirmed in some of Comparative Examples.

The physical property values were measured for the copolymers obtained in Examples and Comparative Examples as well as the coating films obtained from coating film-forming compositions comprising the respective copolymers. The results thereof are summarized in Table 2.

TABLE 2

| | | Molar ratio of structural unit | | | | | | | | |
|---|---|---|---|---|---|---|---|---|---|---|
| | | Monomer | | | | | | Weight- | Number- | |
| | | | (II) | | Other | | | average | average | |
| | | (I) | | PEG | DMA | | | molecular | molecular | |
| | | BMA | MEA | MEMA | EMA | BzMA | MA | weight | weight | |
| | | Tg (° C.) | | | | | | Mw | Mn | |
| | | 20 | −50 | −64 | 18 | 54 | 185 | (×10⁴) | (×10⁴) | Mw/Mn |
| Example | 1 | 0.72 | 0.28 | | | | | 17 | 5.8 | 2.95 |
| | 2 | 0.71 | | 0.29 | | | | 8.9 | 3.3 | 2.74 |
| Comparative | 1 | 1.00 | | | | | | 18 | 4.9 | 3.73 |
| Example | 2 | 0.71 | | | 0.29 | | | 8.9 | 2.7 | 3.31 |
| | 3 | 0.61 | | | 0.19 | | 0.20 | 4.4 | 2.1 | 2.09 |
| | 4 | 0.69 | | | | | 0.31 | 8.7 | 3.6 | 2.42 |
| | 5 | 0.67 | | | | 0.33 | | 22 | 6.8 | 3.18 |

| | | | | Viscoelasticity of coating film | | | |
|---|---|---|---|---|---|---|---|
| | | Surface | | 30 to 40% RH | | 90 to 95% RH | |
| | | zeta | Polymer | Elastic | | Elastic | |
| | | potential | Tg | modulus | Adhesiveness | modulus | Adhesiveness |
| | | (mV) | (° C.) | (MPa) | (nm/nN) | (MPa) | (nm/nN) |
| Example | 1 | 1.35 | −5.1 | 0.56 | 1.70 | 27.8 | 2.60 |
| | 2 | −0.33 | 9.8 | 0.83 | 8.40 | 12.6 | 138.38 |
| Comparative | 1 | 1.21 | 20.0 | 3.20 | 0.02 | 11.7 | 4.25 |
| Example | 2 | 10.9 | 19.5 | 3.87 | 0.02 | 104.5 | 0 |
| | 3 | −4.19 | 54.7 | 2.89 | 0.03 | 44.4 | 0 |
| | 4 | −24.5 | 73.1 | 4.24 | 0.02 | 23.0 | 0 |
| | 5 | 0.85 | 28.9 | 3.38 | 0.02 | 180.5 | 51.71 |

### [Evaluation of Pollen Adsorption Performance]

### (Preparation of Test Piece)

A 5%-by-mass ethanol solution of each polymer of Examples and Comparative Examples was prepared, and a PET sheet of a specific size (manufactured by AS ONE Corporation, thickness: 1 mm, for measurement of pollen density: 20 mm×20 mm, for measurement of number of ruptured pollen: 15 mm×15 mm) was immersed in the thus obtained solution for one day, after which the PET sheet was washed with ethanol and then dried with nitrogen gas, whereby a test piece in which each polymer was laminated on a glass substrate was prepared. The thus obtained test piece was fixed in an antistatic-processed plastic closed container having a bottom surface area of 100 cm²

### (Measurement of Pollen Density and Rupture Rate at Low Humidity)

The test piece prepared in the above-described manner was left to stand for 2 hours under the conditions of room temperature and 30 to 40% RH. Subsequently, 10 mg of pollen particles of each kind were put into the closed container, and this container was attached to a commercially available shaker and left to stand for 10 hours with shaking while maintaining room temperature and 30 to 40% RH. Thereafter, the test piece was taken out, and nitrogen gas was blown thereto to remove the pollen accumulated on the surface, whereby a pollen adsorption test piece was prepared. It is noted here that commercially available products were used as the pollen particles of each kind.

The pollen adsorbed to the thus obtained pollen adsorption test piece in a unit area of 0.55 mm² were observed under a light microscope (magnification: ×10) to count the number of pollen adsorbed to the test piece (pollen density). In addition, the number of ruptured pollen in the same unit area was measured in an SEM image, and the rupture rate of each polymer was calculated by the following equation:

$$Rupture rate ( \% ) = ( Number of ruptured pollen / Number of adsorbed pollen ) \times 100$$

It is noted here that whether or not a pollen was ruptured was judged based on the presence or absence of a crack on the surface of the pollen.

### (Measurement of Pollen Density and Rupture Rate at High Humidity)

The pollen density and the rupture rate at a high humidity were measured in the same manner as in the measurement of the pollen density and the rupture rate at a low humidity, except that the conditions of leaving the test piece to stand with shaking were changed to room temperature and 90 to 95% RH.

### (Humidity Dependence of Rupture Rate)

The humidity dependence of the rupture rate (rupture rate B/A) was calculated by the following equation. It can be said that the smaller the value of the humidity dependence, the more inhibited the rupture of pollen, even in a high-humidity condition where pollen is easily ruptured.

$$Humidity dependence of rupture rate = ( Rupture rate at humidity of 90 to 95 \% RH ) \text{} / ( Rupture rate at humidity of 30 to 40 \% RH )$$

For the coating films that were obtained from coating film-forming compositions comprising the respective polymers obtained in Examples and Comparative Examples, the results of evaluating the pollen adsorption performance in accordance with the above-described methods are summarized in Table 3. It is seen that the coating films obtained from coating film-forming compositions comprising the respective random copolymers of Examples all exhibited excellent pollen adsorption performance and inhibited the rupture of pollen.

TABLE 3

| | | Japanese cedar | | | | | Japanese cypress | | |
|---|---|---|---|---|---|---|---|---|---|
| | | 30 to 40% RH | | 90 to 95% RH | | | 30 to 40% RH | | |
| | | | Rupture | | Rupture | Rupture | | Rupture | 90 to 95% RH |
| | | Density A | rate A | Density B | rate B | rate | Density A | rate A | Density B |
| Tg (° C.) | | (number/cm²) | (%) | (number/cm²) | (%) | B/A | (number/cm²) | (%) | (number/cm²) |
| Example | 1 | 62,312 | 6 | 82,341 | 7 | 1.2 | 57,941 | 47 | 80,873 |
| | 2 | 75,601 | 14 | 76,636 | 14 | 1.0 | 65,859 | 59 | 143,162 |
| Comparative | 1 | 27,558 | 11 | 56,150 | 14 | 1.3 | 12,734 | 55 | 31,628 |
| Example | 2 | 2,369 | 19 | 36,299 | 46 | 2.4 | 2,936 | 72 | 32,930 |
| | 3 | 378 | 10 | 968 | 35 | 3.5 | 1,501 | 62 | 1,468 |
| | 4 | 2,424 | 13 | 2,269 | 10 | 0.8 | 879 | 39 | 1,401 |
| | 5 | 1,090 | 1 | 1,868 | 26 | 3.7 | 9,431 | 44 | 1,335 |

| | | Japanese cypress | | Ragweed | | | | |
|---|---|---|---|---|---|---|---|---|
| | | 90 to 95% RH | | 30 to 40% RH | | 90 to 95% RH | | |
| | | Rupture | Rupture | | Rupture | | Rupture | Rupture |
| | | rate B | rate | Density A | rate A | Density B | rate B | rate |
| Tg (° C.) | | (%) | B/A | (number/cm²) | (%) | (number/cm²) | (%) | B/A |
| Example | 1 | 47 | 1.0 | 43,517 | 1 | 31,128 | 2 | 2.0 |
| | 2 | 60 | 1.0 | 57,885 | 5 | 72,732 | 4.5 | 0.9 |
| Comparative | 1 | 55 | 1.0 | 24,978 | 2 | 7,473 | 4 | 2.0 |
| Example | 2 | 53 | 0.7 | 8,941 | 1 | 11,077 | 11 | 11.0 |
| | 3 | 52 | 0.8 | 667 | 0 | 1,501 | 7 | — |
| | 4 | 51 | 1.3 | 1,835 | 3 | 400 | 4 | 1.3 |
| | 5 | 47 | 1.1 | 3,670 | 5 | 1,501 | 4 | 0.8 |

What is claimed is:

1. A random copolymer, comprising a structural unit represented by Formula (I) and a structural unit represented by Formula (II): 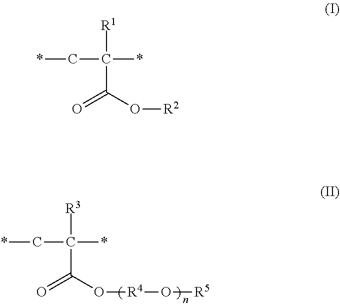
[in Formulas (I) and (II),
R¹ and R³ each independently represent a hydrogen atom or an alkyl group having 1 to 3 carbon atoms;
R² represents an alkyl group having 1 to 6 carbon atoms;
R⁴ represents an alkylene group having 1 to 3 carbon atoms;
R⁵ represents an alkyl group having 1 to 6 carbon atoms;
n represents an integer of 1 to 15; and
* represents a bond with an adjacent structural unit].

2. The random copolymer according to claim 1, wherein the structural unit represented by Formula (II) is derived from a monomer having a Tg of −100 to 15° C.

3. The random copolymer according to claim 1, wherein the amount of the structural unit of Formula (I) is 50 to 99% by mole, and the amount of the structural unit of Formula (II) is 1 to 50% by mole, based on the amount of all structural units of the random copolymer.

4. The random copolymer according to claim 1, having a weight-average molecular weight of 5,000 to 1,000,000.

5. A fine particle adsorbent, comprising the random copolymer according to claim 1.

6. The fine particle adsorbent according to claim 5, wherein a fine particle is pollen.

7. A composition for forming a fine particle-adsorbing coating film, the composition comprising the random copolymer according to claim 1.

8. The composition for forming a fine particle-adsorbing coating film according to claim 7, wherein a fine particle is pollen.

9. The composition for forming a fine particle-adsorbing coating film according to claim 7, further comprising a solvent.

10. A coating film, formed from the composition for forming a fine particle-adsorbing coating film according to claim 7.

11. The coating film according to claim 10, having an elastic modulus of 0.1 to 1.0 MPa and an adhesiveness of 1.0 nm/nN or more.
